(19) United States
(12) Patent Application Publication
(10) Pub. No.: US 2007/0100616 A1
(43) Pub. Date: May 3, 2007

(54) METHOD FOR AUDIO CALCULATION

(75) Inventors: Min-Kun Wang, Hsinchu (TW); Chieh-Yung Tu, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu, TW (TW)

(21) Appl. No.: 11/552,203

(22) Filed: Oct. 24, 2006

(30) Foreign Application Priority Data
Oct. 31, 2005 (TW) 094138175

(51) Int. Cl. G10L 19/02

(52) U.S. Cl. 704/229

(57) ABSTRACT

A method for an audio algorithm is provided. The method includes steps of (a) providing an audio datum, a block division rule of unfixed sample size, and an encoding optimization process; (b) establishing a block from the audio datum by the block division rule of unfixed sample size; (c) obtaining an encoding result by encoding the block with the encoding optimization process; and (d) repeating respective steps (b)-(c) and thereby obtaining a plurality of the blocks.

### FIELD OF THE INVENTION

The present invention relates to a method for audio calculation. More particularly, the present invention relates to providing an ADPCM document for audio calculation.

### BACKGROUND OF THE INVENTION

The method of ADPCM is based on lost compression for waveform data of an audio, wherein a difference between a sample and another one therebehind is preserved to describe the entire waveform. The method of ADPCM includes various types, whereas the core principles therein are basically identical. Following introduce different processing methods of the present ADPCM schemes.

For the method of ADPCM without dividing an audio into blocks, IMA (Interactive Multimedia Association) proposes a method of compression/decompression, wherein an audio in a 16-bit format is processed through ADPCM into that in a 4-bit format. Encoding/decoding methods similar thereto are generally termed as 4-bit ADPCM methods. Following are the descriptions of a 4-bit ADPCM method for audio processing proposed by IMA, wherein the basic formulas for encoding rules are as follows:
Ln=4(Xn−$Xn₋₁)/SSn (1)
$Xn₋₁=$Xn₋₂±D$Xn₋₁ (2)
D$Xn₋₁=SSn₋₁*Ln₋₁(C2C1C0)/4+SSn₋₁/8 (3)
SSn=f2(SPn) (4)
SPn=SPn₋₁+f1(Ln₋₁) (5)

In formula 1, the value of Lₙ is in a range of (−7˜+7); otherwise, it is −7 or +7 if there is overflow thereof. Lₙ is a 4-Bit code, where the highest bit representing a symbol respectively represents a negative or a positive value with a value of 1 or 0. In formula 2, symbols “+” and “−” depending on Lₙ₋₁ are respectively corresponding to a positive value and a negative value thereof. In formula 3, Lₙ₋₁ (C2C1C0) represents the absolute value of Lₙ₋₁ , wherein the effect of symbols is neglected.

In the abovementioned formulas, the index “n” of all the variations represents the parameters corresponding to the nth sample of audio being processed, wherein the index “n−1” represents the parameters corresponding to another sample therebefor. The initialized index of variation is 0 for representing a default value for predetermination. For example, $X0 and SP0 respectively represent acquiesced predictor and stepsize index when predetermined.

Respective variables f2(SPn) and f1(Ln₋₁) in the formulas (4) and (5) are determined respectively as f1(Ln₋₁)=index_table[Ln₋₁] and f2(SPn)=stepsize_table[SPn].

The respective table attributes of index_table[] and stepsize_table[] are as follows:
index_table[8]={−1, −1, −1, 2, 4, 6, 8}
stepsize_table[89]={7,8,9,10,11,12,13,14,16,17, 19,21,23,25,28,31,34,37,41,45,50,55,60,66,73,80,88,97,107,118,130,143, 157,173,190,209,230,253,279,307,337,371,408,449,494,544,598,658,724, 796,876,963,1060,1166,1282,1411,1552,1707,1878,2066,2272,2499, 2749,3024,3327,3660,4026,4428,4871,5358,5894,6484,7132,7845,8630, 9493,10442,11487,12635,13899,15289,16818,18500,20350,22385,24623, 27086,29794,32767}

The abovementioned general formulas are utilized for subsequent algebra algorithm with initialized values, SP0=1, f1(L0)=0, and $X0=0.

Subsequently, the basic formulas for decoding rules are as follows:
$Xn=$Xn₋₁±D$Xn (6)
D$Xn=SSn*Ln(C2C1C0)/4+SSn/8 (7)
SSn=f2(SPn) (8)
SPn=SPn₋₁+f1(Ln₋₁) (9)

The respective parameters in the abovementioned formulas have the same meanings as those for decoding. In common with encoding, the formulas are subsequently utilized with default values, SP0=1, f1(L0)=0, and $X0=0. The abovementioned IMA method for audio processing provides core formulas for ADPCM encoding/decoding for compression, wherein the mere utilization thereof failing to comply with a sound quality after encoding/encoding for compression obviously calls for a sole solution, where the sampling rate is raised, or 4-bit ADPCM is raised to 5-bit one (or higher) for compression. In addition to the increase in the amount of data by changing from 4-bit to 5-bit, the stored data format would be altered to 5-bit, thus producing trouble in preserving and processing data for decoding since the general format for current data bus is 8-bit or 16-bit. Furthermore, the process of the audio product mixed with the methods of 4-bit and 5-bit ADPCM for audio compression would be more complicated and inefficient.

Furthermore, the method of ADPCM by dividing an audio into blocks with a fixed sample size is introduced hereafter. The core algorithm thereof resembles the abovementioned IMA ADPCM method basically, wherein a block is composed of n samples, n=64 for example, and parameters are included therein for optimizing the sound quality thereof. The methods of optimization are different depending on different manufacturers. Following is an example therefor.

As for an example of coding concerned, a block is composed of 64 audio samples, and predictor and stepsize index are reset for the beginning of each block for preservation thereof in an ADPCM document. As for an example of decoding, the block composed of 64 audio samples is composed of 34 bytes through 4-bit ADPCM code, wherein the first two bytes are optimization parameters of a blockhead, and the last 32 bytes are 4-bit ADPCM code, representing 64 audio samples. In the decoding process, the optimization parameters are utilized for resetting parameters, SPn and $Xn in the beginning of each block in the formulas. The algorithm for decoding is the reverse process for encoding, wherein the 4-bit ADPCM code is transformed into 16-bit PCM code. Compared to the method of ADPCM without dividing an audio into blocks, the sound quality by the method of ADPCM by dividing an audio into blocks with a fixed sample size after compression/decompression approaches the level of the original sound, wherein the degree of improvement in the sound quality depends on the optimization rule and the sample size of the block. Under the condition that the sampling rate, the bit number of the data format, and the optimization rule for dividing remain, only shortening a sample size of a divided block is applicable to raising the sound quality after decoding, and thus the compression rate is enormously decreased.

An audio datum through a sampling rate of about 8 k after the abovementioned two methods of decompression general accompany problems in aliasing or bad level of sound quality. For the audio data with more silence samples or requiring higher sound quality thereof, the abovementioned methods for dealing therewith would fail to provide better results in desired sound quality and compression rate.

In order to overcome the drawbacks in the prior art, a method for audio calculation is provided. The particular design in the present invention not only solves the problems described above, but also is easy to be implemented. Thus, the invention has the utility for the industry.

### SUMMARY OF THE INVENTION

It is a first aspect of the present invention to provide an audio algorithm for audio compression through ADPCM.

It is a second aspect of the present invention to provide encoding rules for optimizing audio compression.

It is a third aspect of the present invention to provide a method for an audio algorithm. The method includes steps of (a) providing an audio datum, a block division rule of unfixed sample size, and an encoding optimization process; (b) establishing a block from the audio datum by the block division rule of unfixed sample size; (c) obtaining an encoding result by encoding the block with the encoding optimization process; and (d) repeating respective steps (b)-(c) and thereby obtaining a plurality of the blocks.

Preferably, the encoding result in step (c) is outputted to an adaptive differential pulse code modulation (ADPCM) document.

Preferably, the block division rule of unfixed sample size depends on a characteristic of a different location in the audio datum.

Preferably, the plurality of the blocks are ones selected from a group consisting of a plurality of general blocks, a plurality of silence blocks, and an end block.

Preferably, the plurality of silence blocks are directly outputted to an ADPCM document after a statistic thereof.

Preferably, all audio samples before a specific silence block are adopted as a sample size of a primary general block for primary numbers of the audio samples.

Preferably, the specific silence block is established by audio samples in a specific general block.

It is a forth aspect of the present invention to provide an optimization process for an audio encoding. The optimization process includes steps of (a) providing a first general block, a concept of signal power of minimal error, a concept of instantaneous signal-to-noise-ratio (SNR), and an ADPCM document; (b) obtaining a second general block from the first general block by analyzing a whole error condition thereof; (c) obtaining a third general block from the second general block by analyzing an instantaneous error condition thereof with the concept of signal power of minimal error and the concept of instantaneous SNR; and (d) optimizing the audio encoding and outputting a result thereof to the ADPCM document.

Preferably, each of the first, second, and third general blocks has a block head including a $Xn parameter, which is a calculation result of a first audio sample of the first general block, and an Spn parameter, a choice of which gives an error signal power between an original audio source and a synthesized audio corresponding thereto a minimal value.

Preferably, each of audio samples in the third general block is corresponding to an ADPCM code outputted to the ADPCM document, and the block head and sample size parameter of the third general block are preserved.

Preferably, the error signal power is an accumulation of squared difference values between all audio samples of the first general block and corresponding synthesized audio samples through an operation of a square root of the accumulation through an operation of a division of the square root by a sample size of the first general block.

Preferably, absolute values of synthesized errors of all audio samples of the first general block accumulate into a synthesized accumulated error value (error_Acc), and thereby a threshold thereof is set up as a condition for the process.

Preferably, the second general block is obtained when the error_Acc is smaller than the threshold thereof.

Preferably, the third general block is formulated by audio samples before a specific audio sample, a synthesized instantaneous SNR error (error_snr) of which in the second general block exceeds a threshold thereof.

Preferably, the threshold is one of an index[SNR_abs] and an index[ratio] as a condition for the optimization process for an audio encoding.

It is a fifth aspect of the present invention to provide an optimization process for an audio encoding. The optimization process includes steps of (a) providing a first general block, a concept of signal power of minimal error, a concept of error accumulating, and an ADPCM document; (b) obtaining a second general block from the first general block by analyzing a whole error condition thereof with the concept of signal power of minimal error and the concept of error accumulating; (c) obtaining a third general block from the second general block by analyzing an instantaneous error condition thereof; and (d) optimizing the audio encoding and outputting a result thereof to the ADPCM document

It is a sixth aspect of the present invention to provide an optimization process for an audio encoding. The optimization process includes steps of (a) providing a first general block, a concept of signal power of minimal error, and an ADPCM document; (b) obtaining a second general block from the first general block by analyzing a whole error condition thereof; (c) obtaining a third general block from the second general block by analyzing an instantaneous error condition thereof; and (d) optimizing the audio encoding by the concept of signal power of minimal error and outputting a result thereof to the ADPCM document.

It is a seventh aspect of the present invention to provide a process for audio decoding. The process includes steps of (a) providing an ADPCM document and a decoding method; and (b) decoding a plurality of blocks of the ADPCM document by the decoding method.

Preferably, the ADPCM document is a sequent combination of the plurality of blocks along a time axis.

Preferably, beginnings of the plurality of blocks include a block head utilizing a first byte, a second byte, and a third byte.

Preferably, all data in the ADPCM document except the block head are data through ADPCM.

Preferably, the block is a general block when a value of the first byte is not “1”.

Preferably, a sample size is represented when a value of the first byte is “0”.

Preferably, the block is a silence block for which the decoding method is unnecessary when a value of the first byte is “1”, and a combination datum of the second and third bytes is not “0” for representing a silence size.

Preferably, the block is an end block representing a finishing audio without utilizing the decoding method when a value of the first byte is “1” and a combination datum of the second and third bytes is “0”.

Other objects, advantages and efficacies of the present invention will be described in detail below taken from the preferred embodiments with reference to the accompanying drawings, in which:

### BRIEF DESCRIPTION OF THE DRAWINGS

FIG. 1 is a flow chart of the audio data encoding process in the present invention;

FIG. 2 is a flow chart of the process for the silence block in the present invention;

FIG. 3 is a flow chart of the process for the general block in the present invention; and

FIG. 4 is a flow chart of the audio data decoding process in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

The method of ADPCM for lost compression algorithm is described as follows. Regarding the encoding process based on block division rule of unfixed sample size, the maximal and minimal sample sizes of a block respectively include 256 and 8 audio samples. There are totally three different types of blocks, respectively a general block, a silence block, and an end block, wherein the end block merely represents a finishing audio. As a whole, a silence audio in the audio data to be processed is established as a silence block, wherein the maximal and minimal sample sizes thereof are respectively 65535 and 10. The silence sample size less than 10 is processed in terms of a general block, and the remaining of that more than 65535 is represented by establishing a new silence block. There are three bytes utilized for representing the silence sample size and attributes of the silence block. A certain block in the audio data to be processed is established as a general block if the silence samples therein are zero or more than 10. There are also three bytes utilized for representing the attributes and parameters of the block, wherein messages of block size, $Xn, and SPn are contained, and the minimal size thereof is ruled as 8 bytes.

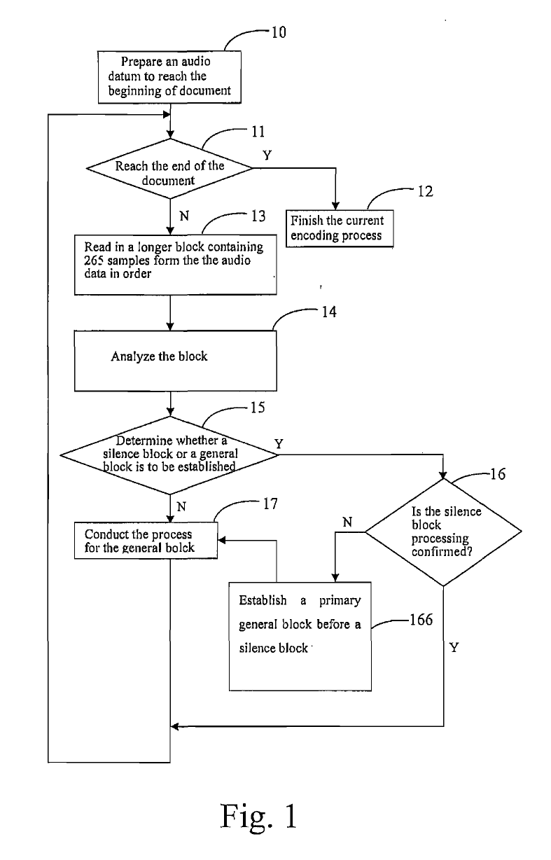

Referring to FIG. 1, which is the flow chart of the audio encoding process in the present invention. The sort of complicated algorithm of the encoding process is hereinafter described in detail and the flow chat thereof is specifically considered. There are two types of effective blocks containing audio samples, which are silence block and general blocks respectively, and the silence block merely stores the number of silence samples in the audio data without demand for the encoding process. When encoding a specific audio datum, sequential blocks are analyzed and coded in order, and results thereby are outputted to an ADPCM document. In the process of analysis and encoding of the block in sequence, audio data to be processed are prepared (step 10), and the current encoding process is finished (step 12) when the end of the document is reached (step 11). If the end of the document is not reached, a longer block containing 265 samples with 256 ones viable therein in maximum is read in from the audio data in order (step 13), thus being analyzed to determining whether at least 10 silence samples are contained for establishing a silence block (step 14) to for confirming whether a silence block or a general block is to be established (step 15). For the silence block to be established and outputted to the ADPCM document, the statistics of silence sample at the beginning of the 265 samples is implemented to determine the occurrence of 10 sequential silence samples for confirming the silence block processing (step 16). For the general block to be established (step 17), a complicated analysis is carried out, whereby a first block of the longer block is selected, the maximal and minimal sample sizes of which are respectively 8 and 256, and thus coded and outputted according to the basic formulas of encoding.

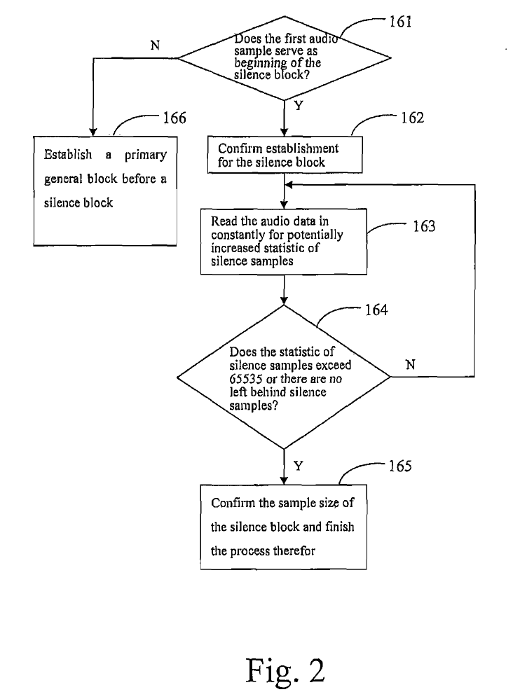

Regarding the statistic of the silence block, please refer to FIG. 2, which is the flow chart of the processing therefor in the present invention. The condition for establishing the silence block is that there are at least 10 continuous silence samples therein. As abovementioned, 265 audio samples are read in first for analysis (step 161), wherein samples before a silence block containing 10 silence sample are established as a primary general block, a sample size of which is uncertain (step 166), and a silence block is surely established (step 162) with over 10 continuous silence samples in the beginning of the audio samples, which are outputted to the ADPCM document after a statistic thereof. If the 265 audio samples are all silence samples, the audio data would be read in constantly for potentially increased statistic thereof (step 163) until the ended statistic reaches a number of 65535 or there are no silence samples left behind (step 164) for outputting the silence block to the ADPCM document (step 165). In case there are silence samples left behind, a new silence block is established for preservation thereof.

It could be understood by the abovementioned descriptions that the 265 audio samples are read in for a primary analysis considering that the end of the 256 audio samples might have silence samples less than 10, which could constitute a silence block with audio samples therebehind. If an analysis of 265 audio samples is performed, whether the sole 256^{th} audio sample existing in the end of the 256 audio samples belongs to the current general block or the silence block to be processed could be decided by the analysis of the audio samples therebehind.

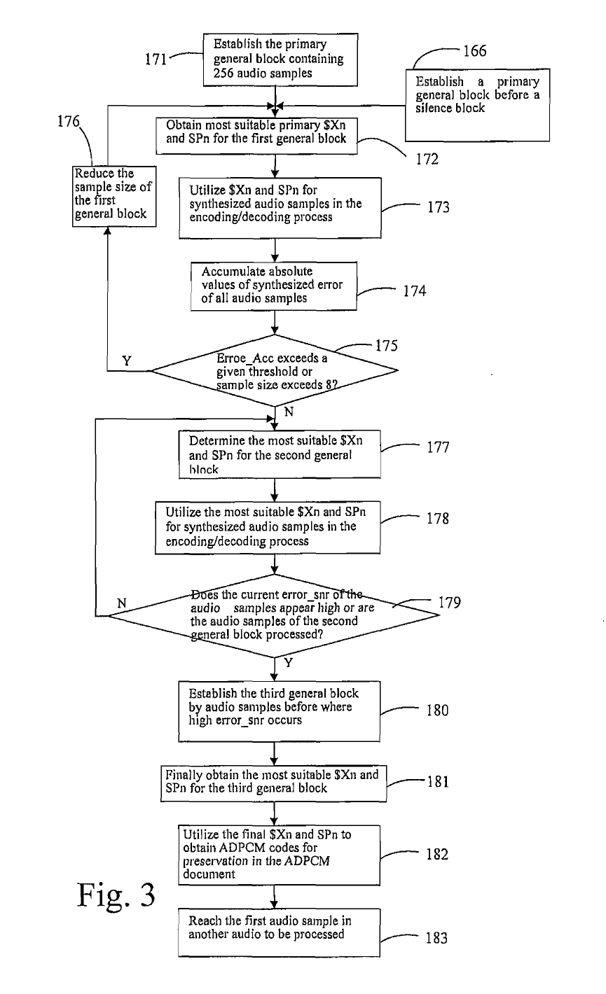

Please refer to FIG. 3, which is a flow chart of the encoding process in the general block of a preferred embodiment in the present invention. For a general block to be established, there are at least 8 audio samples contained therein, and the 265 audio samples are read in for analysis, wherein the establishment thereof is recognized and thus two possible conditions are considered for a primary general block sample block if the beginning thereof fails to meet the condition for a silence block.

In the first condition, in the 265 audio samples, a silence block is established by over 10 sequential audio samples therein, and all other audio samples before the silence block are adopted as a number size of audio samples for the primary general block (step 166). If the number size is smaller than 8, audio samples behind the adopted are thus included as a compensation for at least 8 audio samples. In the second condition, if no silence block manages to be established in the 265 audio samples, the first 256 audio samples therein are adopted as a primary general block sample size (step 171). For convenience of description, the determined primary general block is expressed as a first general block and the audio samples thereof are adopted for the primary general block sample size, followed by an analysis with three steps.

In the first step, the first general block is analyzed through a concept of signal power of minimal error and a concept of error accumulating, whereby a whole error condition is thus analyzed and a new block is obtained therefrom based on the error therein, while the corresponding sample size may be altered. The audio data constituting the new block would meet the limitation on the threshold of error accumulating. Following is a detailed description.

The most suitable $Xn and SPn are obtained for the first general block (step 172). &Xn is the first audio sample in the first general block, wherein the lower 7 bits are configured as 0 and added to 40 H. SPn is obtained by trial. In the process of encoding and decoding audio samples of the first general block, the available minimal and maximal values for SPn are calculated for corresponding signal power of minimal errors, wherein the value corresponding to the minimal signal power of minimal error corresponds to the most suitable SPn, the error signal power of which is an accumulation of squared difference values between all audio samples of the first general block and corresponding synthesized audio samples through an operation of a square root of the accumulation through an operation of a division of the square root by a sample size of the first general block (step 173).

The obtained most suitable &Xn and SPn after calculation are utilized to determine a synthesized accumulated error value (error_Acc), which is the accumulation of absolute values of synthesized error of all audio samples (step 174). If in step 175 error_Acc exceeds a given threshold thereof, which is index[Acc], the sample size of the first general block is thus reduced (step 176), wherein suitable &Xn and SPn are calculated through the remaining audio samples to obtain new error_Acc for comparison to index[Acc] based on the abovementioned method. If error_Acc is still higher than index[Acc], the abovementioned process is thus repeated with a deletion of 8 audio samples so as to achieve a calculated error_Acc lower than index[Acc] or obtain a general block sample size about to be smaller 8, for the designated least number thereof is 8. Thus the determined block is termed as a second general block, and the audio sample size thereof is expressed as block2size for the following analysis.

In the second step, the second general block is analyzed through a concept of instantaneous signal-to-noise-ratio (SNR), whereby an instantaneous error condition is thus analyzed and a new block is obtained therefrom, while the corresponding sample size may be altered. The audio data constituting the new block would meet the limitation on the threshold thereof. Following is a detailed description.

For the block2size audio samples determined in the second general block, the most suitable $Xn and SPn corresponding thereto are obtained through a concept of signal power of minimal error (step 177), and the encoding and decoding processes are performed on each of the audio sample (step 178), wherein for a synthesized instantaneous SNR error (error_snr) of a specific audio sample with an exceeding synthesized error higher than a predetermined threshold thereof (179), all audio samples therebefore are adopted for establishing a new block, temporarily termed as a third general block (step 180), the number of audio samples of which is block3size. In the same way, block3size is confirmed to be at least 8, wherein an audio sample therein with an exceeding error is ignored for the confirmation. The threshold of error_snr is adopted as the absolute value of the difference between the original audio sample and the synthesized audio sample, which is index[SNR_abs], if the absolute value of the difference between the original audio sample and the silence sample is beneath 1024. For the original audio sample farther than the silence sample, thereby the absolute value of the difference therebetween being beyond 1024, the threshold of error_snr is adopted as the ratio index[SNR_ratio] through the absolute value of the difference therebetween divided by the value of the original audio sample.

The final third general block and a sample size of block3size corresponding thereto are thus obtained. How to establish a general block therefrom, calculate the ADPCM codes for the entire audio sample therein, and output the codes and block head of the general block to the ADPCM document are the remaining problems to be solved. Following is a detailed description.

For the block3size audio samples in the third general block, the most suitable &Xn and SPn therefor are obtained (step 181 ) through a concept of signal power of minimal error, and the number of block3size and the block head are preserved in the ADPCM document (step 182), wherein the messages in the block head are $Xn and SPn. Actually, the value from the lower 7 bits configured as 0 in the first audio sample in the third general block is $Xn, termed as &Xn[1], wherein the value of the block head is $Xn[1] added to SPn, and $Xn for encoding and decoding calculation is $Xn[1] plus 40 H. After the number of block3size and the block head are preserved, each ADPCM code is determined through basic ADPCM encoding formulas and outputted to the ADPCM document.

At present a general block is thus obtained through calculation. All the remaining audio samples therebehind are subsequently dealt with through the abovementioned analysis and decoding process until the entire audio datum is finished (step 183). In the above embodiment, at least 8 audio samples are adopted for a general block because the ADPCM document would be enlarged with bad quality of compression from an extremely low number of audio samples. Moreover, the specified rule for the number of at least 8 audio samples is ignored if the number of the remaining audio samples at the end of the process for the audio datum is beneath 8. In other words, the number of audio samples in the last general block at the end of the ADPCM document is perhaps beneath 8.

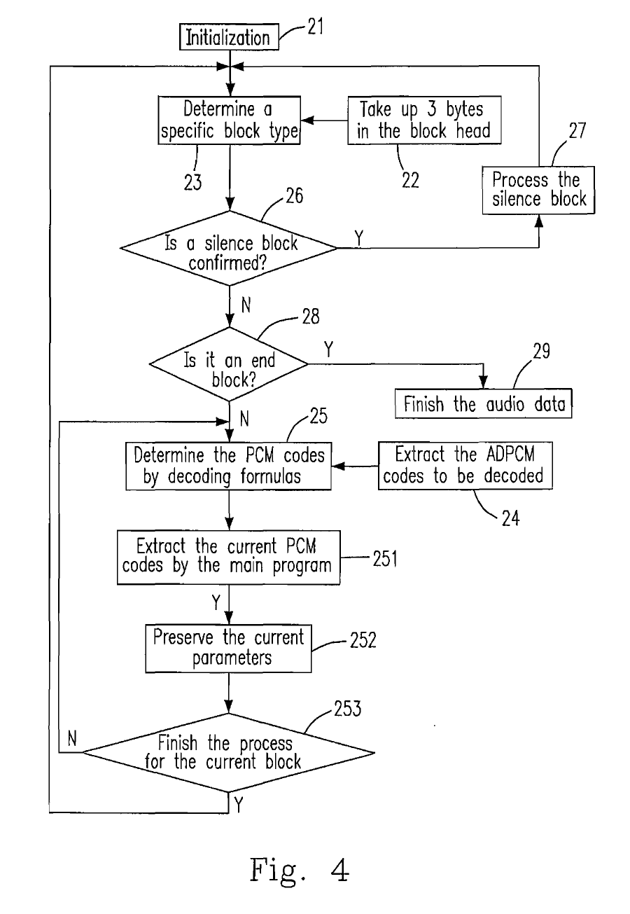

Please refer to FIG. 4, which is a flow chart of the audio decoding process of a preferred embodiment in the present invention. Take the ADPCM document after encoding of compression through 4-bit ADPCM for example, a plurality of blocks therein are viewed as sequent combinations along a time axis, wherein the higher 4 bits in the current byte follow the lower 4 bits in the current byte following the lower 4 bits in the prior byte. There are totally 3 distinct types of blocks in the ADPCM document provided in the present invention, which are the general block, the silence block, and the end block respectively. Regardless of the differences thereamong, the block head in the beginning of each of the blocks takes up 3 bytes (step 22) for determination of a specific block type (step 23) and estimating the messages and parameters thereof. Following is a detailed description.

A general block is confirmed when the value of the first byte of the block head thereof is not 1, wherein the value of the first byte represents the number of 16-bit audio samples for the sample size of the block and the value of 0 represents the number of 256 audio samples. Subsequently, the second and third bytes serve as a datum, wherein the higher 9 bits represent $Xn in the abovementioned decoding method, and the lower 7 bits represent SPn. Following is a description as to extracting the messages in the two bytes and thereby obtaining the values of prediction, &Xn, and step index, SPn.

For an example as “xxxxxxxxxiiiiiii”, the 9 bits of “x” therein represent the predictor to be reset for the current block. A value of 40 H is added to the value of the example for an error from the lower 7 bits ignored in the predictor to thereby decrease a whole error, wherein 40 H is the intermediate value of the error, and the 7 bits of “i” represent the value of SPn.

The data after the block are ADPCM codes (step 24). Accordingly, the first PCM code decoded in the general block is “$Xn+40 H” (step 25), and the second is determined by SPn provided in the block head in the abovementioned method. The third and following PCM codes are thereby obtained through basic formulas in the decoding process.

ADPCM code is a datum of 4 bits, and therefore it is a problem for the storage thereof in a computer with data stored in byte when the remaining ADPCM code of 4 bits is not processed and not stored along with a code prior thereto in one byte after extracting the current PCM codes by the main program (step 251). If a sparing block is not chosen, the ADPCM code is preserved in byte (step 252), wherein the higher 4 bits are null. If the sparing block is chosen, the ADPCM code is thus preserved in byte, wherein the higher 4 bits are effective for storing the first ADPCM code in the next general block. Therefore, the process for the current block is finished (step 253).

If the value of the first byte in the block head is 1, the second and third bytes serve as a combination datum, wherein a silence block is thus confirmed (step 26) if the value of the combination datum is not 0, and the confirmation datum implies that there are silence samples of a silence sample size for subsequent PCM audio samples. Thus the abovementioned formulas are not utilized (step 27). If the value of the first byte in the block head is 1, the second and third bytes thus serve as a combination datum, wherein an end block is confirmed (step 28) if the value of the combination datum is 0. The end block merely represents a finishing audio (step 29).

As abovementioned, the optimization process for audio encoding in the present invention is incorporated with various quantified error indices for allowing a user to adjust the maximal threshold of quantified error indices according to the required audio quality and compression rate in practice to obtain satisfactory results thereof.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for an audio algorithm, comprising steps of:
(a) providing an audio datum, a block division rule of unfixed sample size, and an encoding optimization process;
(b) establishing a block from the audio datum by the block division rule of unfixed sample size;
(c) obtaining an encoding result by encoding the block with the encoding optimization process; and
(d) repeating respective steps (b)-(c) and thereby obtaining a plurality of the blocks.

2. The method as claimed in claim 1, wherein the encoding result in step (c) is outputted to an adaptive differential pulse code modulation (ADPCM) document.

3. The method as claimed in claim 1, wherein the block division rule of unfixed sample size depends on a characteristic of a different location in the audio datum.

4. The method as claimed in claim 1, wherein the plurality of the blocks are ones selected from a group consisting of a plurality of general blocks, a plurality of silence blocks, and an end block.

5. The method as claimed in claim 4, wherein the plurality of silence blocks are directly outputted to an ADPCM document after a statistic thereof.

6. The method as claimed in claim 4, wherein all audio samples before a specific silence block are adopted as a sample size of a primary general block for primary numbers of the audio samples.

7. The method as claimed in claim 6, wherein the specific silence block is established by audio samples in a specific general block.

8. An optimization process for an audio encoding, comprising steps of:
(a) providing a first general block, a concept of signal power of minimal error, a concept of instantaneous signal-to-noise-ratio (SNR), and an ADPCM document;
(b) obtaining a second general block from the first general block by analyzing a whole error condition thereof;
(c) obtaining a third general block from the second general block by analyzing an instantaneous error condition thereof with the concept of signal power of minimal error and the concept of instantaneous SNR; and
(d) optimizing the audio encoding and outputting a result thereof to the ADPCM document.

9. The process as claimed in claim 8, wherein each of the first, second, and third general blocks has a block head including:
a $Xn parameter, which is a calculation result of a first audio sample of the first general block; and
an Spn parameter, a choice of which gives an error signal power between an original audio source and a synthesized audio corresponding thereto a minimal value.

10. The process as claimed in claim 9, wherein each of audio samples in the third general block is corresponding to an ADPCM code outputted to the ADPCM document, and the block head and sample size parameter of the third general block are preserved.

11. The process as claimed in claim 9, wherein the error signal power is an accumulation of squared difference values between all audio samples of the first general block and corresponding synthesized audio samples through an operation of a square root of the accumulation through an operation of a division of the square root by a sample size of the first general block.

12. The process as claimed in claim 8, wherein absolute values of synthesized errors of all audio samples of the first general block accumulate into a synthesized accumulated error value (error_Acc), and thereby a threshold thereof is set up as a condition for the process.

13. The process as claimed in claim 12, wherein the second general block is obtained when the error_Acc is smaller than the threshold thereof.

14. The process as claimed in claim 8, wherein the third general block is formulated by audio samples before a specific audio sample, a synthesized instantaneous SNR error (error_snr) of which in the second general block exceeds a threshold thereof.

15. The process as claimed in claim 14, wherein the threshold is one of an index[SNR_abs] and an index[ratio] as a condition for the optimization process for an audio encoding.

16. An optimization process for an audio encoding, comprising steps of:
(a) providing a first general block, a concept of signal power of minimal error, a concept of error accumulating, and an ADPCM document;
(b) obtaining a second general block from the first general block by analyzing a whole error condition thereof with the concept of signal power of minimal error and the concept of error accumulating;
(c) obtaining a third general block from the second general block by analyzing an instantaneous error condition thereof; and
(d) optimizing the audio encoding and outputting a result thereof to the ADPCM document

17. An optimization process for an audio encoding, comprising steps of:
(a) providing a first general block, a concept of signal power of minimal error, and an ADPCM document;
(b) obtaining a second general block from the first general block by analyzing a whole error condition thereof;
(c) obtaining a third general block from the second general block by analyzing an instantaneous error condition thereof; and
(d) optimizing the audio encoding by the concept of signal power of minimal error and outputting a result thereof to the ADPCM document.

18. A process for audio decoding, comprising steps of:
(a) providing an ADPCM document and a decoding method; and
(b) decoding a plurality of blocks of the ADPCM document by the decoding method.

19. The process as claimed in claim 18, wherein the ADPCM document is a sequent combination of the plurality of blocks along a time axis.

20. The process as claimed in claim 18, wherein beginnings of the plurality of blocks include a block head utilizing a first byte, a second byte, and a third byte.

21. The process as claimed in claim 20, wherein all data in the ADPCM document except the block head are data through ADPCM.

22. The process as claimed in claim 20, wherein the block is a general block when a value of the first byte is not “1”.

23. The process as claimed in claim 20, wherein a sample size is represented when a value of the first byte is “0”.

24. The process as claimed in claim 20, wherein the block is a silence block for which the decoding method is unnecessary when a value of the first byte is “1”, and a combination datum of the second and third bytes is not “0” for representing a silence size.

25. The process as claimed in claim 20, wherein the block is an end block representing a finishing audio without utilizing the decoding method when a value of the first byte is “1” and a combination datum of the second and third bytes is “0”.
